(19) United States
(12) Patent Application Publication
(10) Pub. No.: US 2014/0292234 A1
(43) Pub. Date: Oct. 2, 2014

(54) PLASMA HYDROGEN GENERATION DEVICE FOR NEW ENERGY CAR

(71) Applicant: National Cheng Kung University, Tainan City (TW)

(72) Inventors: Yasushi Nishida, Tainan (JP); Chio-Zong Cheng, Kaohsiung (TW); Chung-Ming Liu, Miaoli County (TW)

(73) Assignee: National Cheng Kung University, Tainan City (TW)

(21) Appl. No.: 14/227,015

(22) Filed: Mar. 27, 2014

(30) Foreign Application Priority Data
Mar. 28, 2013 (TW) 102111271

(51) Int. Cl. H01M 8/06; B60L 11/18; H01M 16/00

(52) U.S. Cl. CPC H01M 8/0618; H01M 8/0631; H01M 16/006; B60L 11/18
USPC 318/139; 429/9; 123/2

(57) ABSTRACT

A plasma hydrogen generation device includes a liquid fuel storage bottle, an air filtering element, a large capacitor battery and a fuel cell power set. In operation, the carbon hydrogen compound is decomposed into hydrogen and carbon without carbon dioxide generation when a liquid carbon hydrogen compound is decomposed in the plasma hydrocarbon decomposition element. The produced hydrogen is directly provided to fuel cells on the car to generate electric power. As such, the resulting electric power may be directly used for the electric motor driving system on the car. Further, it is also suitable for a home electric power supply device with home or industry electricity specification, or used in combination with an electric vehicle (EV) car driving system to become a hydrogen hybrid EV car, or used in combination with a natural gas internal combustion engine to become a hydrogen hybrid car driving system.

### FIELD OF THE INVENTION

The present invention is related to a hydrogen generation device used for a new energy car, particularly to that a fuel cell and hybrid dynamic system for such car, and particularly to a fuel cell and high capacity battery system used for a hydrogen hybrid power driving car.

### DESCRIPTION OF THE RELATED ART

In recent years, the use of petrochemical energy and thus the generation of carbon oxide and nitrogen oxides have led to a continuous degradation of greenhouse effect. In addition, with lesser and lesser energy sources based on fossil fuels left in the world storage, the issue of energy use and environmental pollution can be solved by the fuel cell technology based on non-petrochemical fuels. For the past decades, the fuel cell has had a breakthrough development. Hydrogen-based fuel cell has been considered having a significant potential for electricity generation and transportation usage. Hydrogen is well known to be the optimal clean energy and may be an energy source for the fuel cell and is used in many applications. In the hydrogen-based fuel cell technology, the hydrogen generation, storage and delivery must be considered from an overall energy efficiency point of view. Thus, the best method of hydrogen generation and delivery should be determined.

The currently used hydrogen production and supplying system is performed by manufacturing hydrogen in factory and compressing it as a liquid state, and then filling the compressed hydrogen into the hydrogen fuel tank of a car. However, this may consume a large amount of additional energy, because not only the energy for generation of hydrogen by using gaseous carbon hydrogen compound and dissolving steam is required, but liquidation of hydrogen, introduction of the liquid hydrogen into the fuel tank and carrying of the fuel tank to a hydrogen supply station require also a large amount of energy.

For example, in the course of introducing hydrogen into the fuel tank, the liquid hydrogen needs to be maintained at a high pressure of 35 MPa and a low temperature of 21K. Otherwise, the fuel tank cannot carry sufficient amount of hydrogen for the required electricity generation by using the fuel cell. In fact, the energy required for condensing hydrogen gas to liquid state is about 100 times that for propane of the same weight.

At present, mixed materials of carbon hydrogen compound (hydrocarbon) and steam are used in the hydrogen generation system, by decomposing the mixed materials under a temperature (600˜1200° C.) with presence of a catalyzing agent. However, such hydrogen generation system is not suitable for use on a car. In addition, the requirement of water for such decomposition also reduces energy efficiency and the carbon dioxide will also be produced simultaneously. In view of this, a more clean energy gas production system has to be developed,

### SUMMARY OF THE INVENTION

It is, therefore, an objective of the present invention to overcome the shortcoming inherited in the prior hydrogen production and delivery system and provide a plasma hydrogen generation device used for a new energy car, in which a hydrogen carbon compound is decomposed into hydrogen and carbon, hydrogen is highly efficiently generated and purified, and the purified hydrogen is used by a fuel cell without carbon dioxide generated in the process.

The secondary, but most important objective of the present invention is to provide a plasma hydrogen generation device on a car. The hydrogen generated by the plasma hydrogen generation device may be directly used by a fuel cell on the car for providing electric power to drive the car, and thus the plasma hydrogen generation device is suitable for use in a series of clean and green energy cars. Further, it is also suitable as an electric power supply device with home and industry electricity specification. Or, this system can be used in combination with a driving system to become a hydrogen hybrid electric car, or used in combination with an internal combustion engine to provide a hydrogen hybrid car driving system.

To achieve the above objectives, the plasma hydrogen generation device for a new energy car comprises: of a liquid fuel bottle, supplying a liquid carbon hydrogen compound as a fuel; an air filtering element, consisting of a filtering cavity having a filtering entrance and a filtering exit, having a first filtering area and a second filtering area, receiving the liquid carbon hydrogen compound from the liquid fuel storage bottle through the filtering cavity entrance and filtering the liquid carbon hydrogen compound to remove an air contained in the gaseous carbon hydrogen compound; a plasma hydrocarbon decomposition element, consisting of a plasma cavity having a plasma cavity entrance communicated to the filtering cavity exit and a plasma cavity exit, and being composed of a plasma reactor and a covering of the plasma reactor, the plasma reactor having a plasma hydrocarbon decomposition area and at least a pair of electrodes, the pair of electrodes containing a plurality of catalyst particles for increasing an electric field, wherein the plasma hydrocarbon decomposition element guides the air filtered gaseous hydrocarbon into a plasma hydrocarbon decomposition area thereof, in which the gaseous carbon hydrogen compound is decomposed into hydrogen gas and carbon particles by discharging at a discharging space within the pair of electrodes by applying a high voltage short rise time impulse, and then the gas filtering element purifies the output hydrogen by removing the carbon particles mixed in the hydrogen and a portion of carbon hydrogen compound without being decompressed out of the gaseous carbon hydrogen compound originally in the gas filtering gas; a high voltage power supply, connected to the pair of electrodes of the plasma hydrocarbon decomposition element to supply a high voltage impulse power for operating the plasma reactor; a fuel cell power set, connected to the plasma hydrocarbon decomposition element for receiving the purified hydrogen to generate electric power; and a large capacitor battery, receiving the electric power and supplying the electric power to the high voltage power supply.

In an embodiment, the plasma hydrogen generation device may be directly used in a car, and provides electric power to a large capacitor battery for charging. Or, the hydrogen generation device directly provides electric power to a motor driving system of an electric vehicle (EV) and is also suitable for a home electric power supply device with home or industry electricity specification.

In an embodiment, the plasma hydrogen generation device is used in combination with an internal combustion engine with liquid carbon hydrogen compound as fuel to become a hydrogen hybrid car driving system, in which it supplies electric power to a large capacitor battery system for charging or directly supplies electric power to a motor driving system of an EV car to become a hydrogen hybrid car driving system. In operation of the internal combustion engine, the electric power generated is partly supplied to the large capacitor battery while the other to the car driving system. Alternatively, the large capacitor battery may also use an external power for charging.

In an embodiment, the plasma hydrogen generation device may be further used in combination with an EV car, to make a hydrogen hybrid EV car, and provides electric power to the large capacitor battery for charging, or provides electric power to the motor driving system to become a hydrogen hybrid EV car, in which the large capacitor battery mainly provides electric power to the motor driving system and partly to the plasma hydrocarbon decomposition element. Alternatively, the large capacitor battery may also use an external power for charging.

### BRIEF DESCRIPTIONS OF THE DRAWINGS

The present invention will be better understood from the following detailed descriptions of the preferred embodiments according to the present invention, taken in conjunction with the accompanying drawings, in which:

FIG. 1 is a schematic diagram of a basic architecture of a plasma hydrogen generation device according to the present invention;

FIG. 2A is a cross sectional view of a gas pipe connector cut along a symmetrical axis according to an embodiment of the present invention;

FIG. 2B is a local cross sectional view of the gas pipe connector cut along a symmetrical axis according to another embodiment of the present invention;

FIG. 3A is a schematic diagram of an electrode structure according to a preferred embodiment of the present invention;

FIG. 3B is a schematic diagram of the electrode structure according to another preferred embodiment of the present invention;

FIG. 3C is a schematic diagram of the electrode structure according to yet another preferred embodiment of the present invention;

FIG. 4 is a schematic diagram of a used state of the plasma hydrogen generation device according to a preferred embodiment of the present invention;

FIG. 5 is a schematic diagram of a used state of the plasma hydrogen generation device according to another preferred embodiment of the present invention; and

FIG. 6 is a schematic diagram of a used state of the plasma hydrogen generation device according to yet another preferred embodiment of the present invention.

### DESCRIPTION OF THE PREFERRED EMBODIMENTS

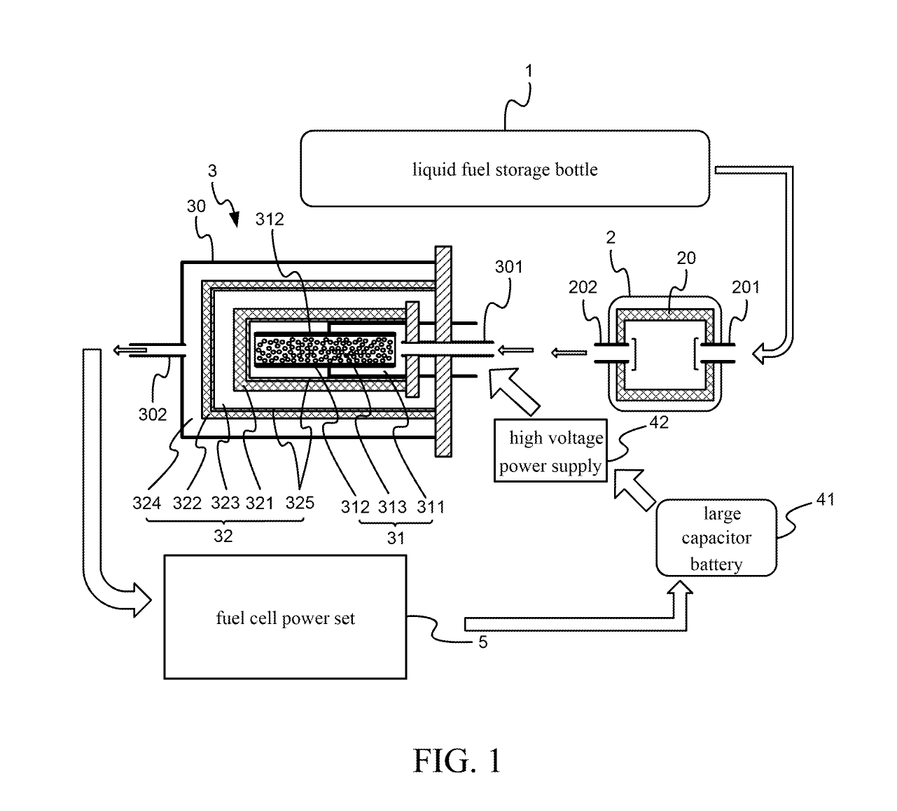

Referring to FIG. 1, a schematic diagram of a basic architecture of a hydrogen plasma device according to the present invention is shown therein. As shown, the present invention provides a plasma hydrogen device used for a new energy car capable of hydrogen generation and purification and operation with fuel cell batteries with high efficiency. In the device, purified hydrogen can be directly generated with input of a carbon hydrogen compound, and the hydrogen thus obtained can be used to generate electric power with help of fuel cell, which is suitable for use in a car for providing electric power to the car, driving the car or charging a battery on the car.

The plasma hydrogen device comprises a liquid fuel storage bottle 1, an air filtering element 2, a plasma hydrocarbon decomposition element 3, a high voltage power supply 42, a large capacitor battery 41 and a fuel cell power set 5.

The liquid fuel storage bottle 1 stores liquid carbon hydrogen compound inside, which is liquid natural gas, comprising methane, propane, or butane.

The air filtering element 2 comprises a filtering cavity 20. The filtering cavity 20 has a filtering entrance 201 and a filtering exit 202. The filtering cavity entrance 201 receives the liquid carbon hydrogen compound from the liquid fuel storage bottle 1 at the filtering cavity entrance 201 and filters out the liquid carbon hydrogen compound to remove air contained in the gaseous carbon hydrogen compound.

The plasma hydrocarbon decomposition element 3 comprises a plasma cavity 30. The plasma cavity 30 has a plasma cavity entrance 301 and a plasma cavity exit 302. The plasma cavity entrance 301 is connected to the filtering cavity exit 202 of the air filtering element 2. The plasma hydrocarbon decomposition element 3 is composed of a plasma reactor 31 and a double-layered gas filter 32 covering the plasma reactor 31. The plasma reactor 31 is an internal decomposition type reactor and has a plasma hydrocarbon decomposition area 311 and at least a pair of electrodes 312. The pair of electrodes 312 contains a plurality of either catalyst particles 313 for increasing an electric field or without catalyst particles. The gas filtering element 32 is communicated to the plasma cavity entrance 301 and comprises a first filtering area 323 and a second filtering area 324.

The plasma hydrocarbon decomposition element 3 draws air out to a vacuum for the plasma cavity 30 and guides the air filtered gaseous carbon hydrogen compound into a plasma hydrocarbon decomposition area 311 of the plasma reactor 31 at the cavity entrance 301.

A high voltage impulse power generator applies a voltage impulse with short rise time at a discharging space between the pair of electrodes 312, and the gaseous carbon hydrogen compound is decomposed into hydrogen gas and carbon particles. The gas filtering element 32 is then used to purify the hydrogen thus outputted to remove the carbon particles and remaining undecomposed gaseous carbon hydrogen compound.

The high voltage power supply 42 is connected to the pair of electrodes 312 of a plasma hydrocarbon decomposition element 3, to provide the high voltage impulse power required for operation of the plasma reactor 31.

The fuel cell power set 5 is connected to the plasma hydrocarbon decomposition element 3 for receiving the purified hydrogen to generate electric power.

The large capacitor battery 41 is used to receive the electric power from the fuel cell power set 5 and supplies the electric power to the high voltage power supply 42.

The filtering cavity 20 of the air filtering element 2 is a cavity with a wall composed of a filtering layer only absorbing air molecules without absorbing the carbon hydrogen compound. The fuel uses high pressure carbon hydrogen compound and may push the air molecules out of the filtering layer. In an embodiment, that a connection terminal is connected to the air filtering element is used to replace the air filtering element.

The plasma reactor 31 may be a shield discharging plasma reactor or a dielectric catalyst plasma reactor in order to avoid noise disturbance to the outer systems.

The plasma cavity 30 is made of stainless steel or other conductive materials and has a volume of 30 cm×706 cm², which can be varied, depending on the required plasma capacities.

In the pair of electrodes 312, each of the catalyst particles may be aluminum phosphate (AlPO₄), aluminum oxide (Al₂O₃), barium titanium oxide (BaTiO₃) and many others are also available. However, the catalysts particles are not necessarily required, depending on the plasma conditions under usage

The air filtering element 32 is a double-layered structure having an internal layer filtering unit 321 and an external layer filtering unit 322 covering the internal filtering unit 321. The internal filtering unit 321 is arranged circumferentially outside the plasma hydrocarbon decomposition area 311 of the plasma reactor 31.

The gaseous carbon hydrogen compound is decomposed by the plasma discharge into a mixture of hydrogen, carbon particles and undecomposed gaseous carbon hydrogen compound, in the following thus termed.

The internal filtering unit 321 first blocks the carbon particles when the mixture flows to the internal filtering unit 321, then the external filtering unit 322 of the first filtering area 323 filters out the undecomposed gaseous carbon hydrogen compound when the mixture of the hydrogen and the undecomposed carbon hydrogen flows to the external filtering unit 322. The remaining hydrogen is purified when it comes to the second filtering area 324.

The undecomposed carbon hydrogen compound without passing the external filtering unit 322 is collected and recycled to the plasma reactor 31 for further decomposition.

Further, the internal filtering unit 321 may be designed as only being passed by hydrogen. In addition, each internal wall of the external filtering unit 322 and the internal filtering unit 321 are composed of an isolation assembly 325, which may be a porous ceramic material, forming an isolation space.

The first filtering area 323 has a pressure smaller than that of the plasma hydrocarbon decomposition area 311 and greater than that of the second filtering area 324 which is greater than 1 atm.

As such, the inventive plasma hydrogen generation device used for a new energy car is constructed. In the operation of the present invention, the liquid carbon hydrogen compound stored in the liquid fuel storage bottle 1 is filtered out with air (nitrogen and oxygen) through the air filtering element 2 and then directly delivered to the plasma hydrocarbon decomposition element 3. In the plasma reactor 31, a plasma discharging technology is used to decompose the gaseous carbon hydrogen compound into hydrogen and carbon particles. After the hydrogen is purified in the double-layered gas filtering element 32, the purified hydrogen is taken out from the plasma cavity 30, and directly provided to the fuel cell power set 5 in the car. The carbon particles are stored in the plasma reactor 31 without flowing out, and may be taken out in a routine reactor cleaning access.

In addition, in the plasma hydrocarbon decomposition area 311, the pressure is maintained higher than the ambient. For the sake of safety, the pressure of the plasma hydrocarbon decomposition area 311 must be higher than 1 atmospheric pressure (atm) and lower than 10 atm. As such, the internal filtering unit 321 has an improved filtering result, and thus a large portion of carbon particles can be filtered out.

Under such circumstance, gaseous carbon hydrogen compound and hydrogen can pass the internal filtering unit 321 at the same time, or only let hydrogen passes.

In this invention, a voltage impulse with a very short rising time is adopted to improve the decomposition efficiency of the carbon hydrogen compound. A high voltage power supply 42 provides a voltage impulse having a repetition frequency between 1 KHz and 1 MHz, and a pulse width between 1 ns and 1 μs.

According to the experiments, such voltage impulse can reduce the energy consumed in heating the gas in the plasma area, and avoid heating the surrounding gas residue which is the large portion of the discharging energy loss corresponding to the voltage impulse. Therefore, it is a feature of the present invention that a short rise time and short duration impulse is provided to reduce energy consumption in the plasma hydrocarbon decomposition devices used on a car. By performing this system, no liquidation of hydrogen is required. Compared with the current hydrogen liquidation system, this technical feature of the present invention may save a large amount of energy.

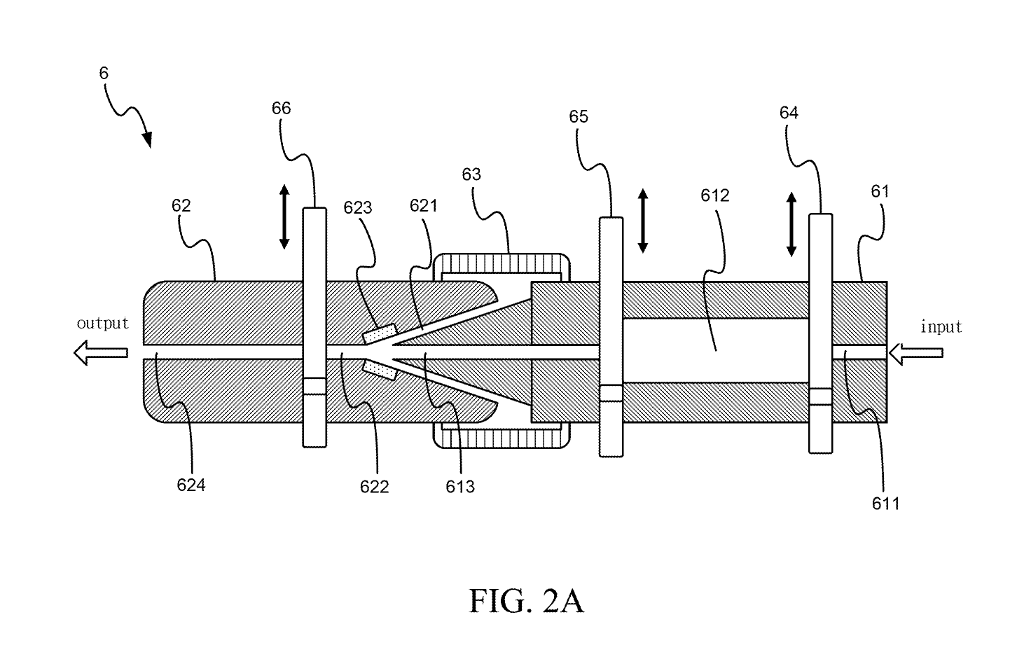

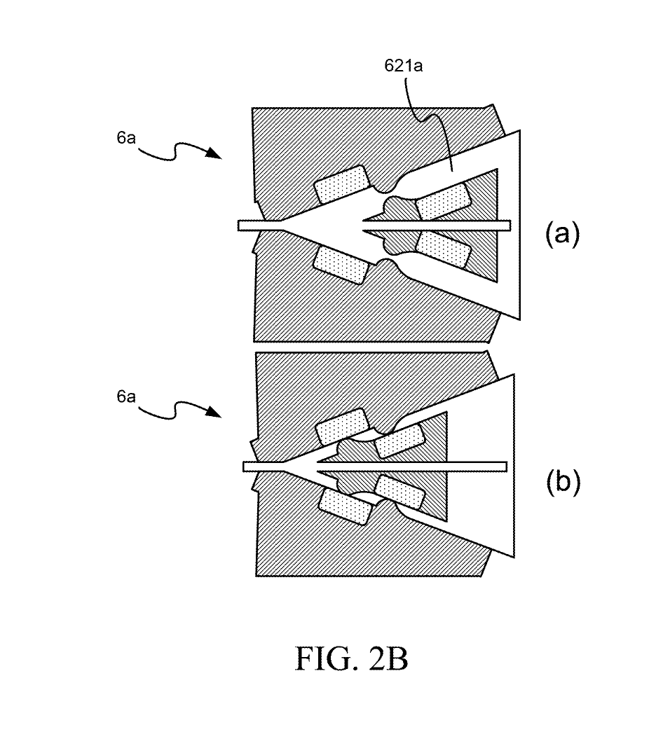

Referring to FIG. 2A and FIG. 2B, a cross sectional view of a gas pipe connector cut along a symmetrical axis according to a preferred embodiment of the present invention, and a local cross sectional view of the gas pipe connector cut along a symmetrical axis according to another embodiment of the present invention are respectively shown. As shown, an alternative filtering method for removing air is to further arrange an air pipe connector 6 between the liquid fuel storage bottle and the plasma hydrocarbon decomposition element 3. And the air filtering element 2 may be replaced with the gas pipe connector 6, or they can be used together.

In FIG. 2A, the shown gas pipe connector 6 is an axial symmetric structure, which comprises an admission assembly 61, an outlet assembly 62, an auxiliary connector 63 and a plurality of movable valves 64, 65, 66. The admission assembly 61 is connected to the liquid fuel storage bottle 1 and comprises an admission pipe 611, a natural gas filling area 612 and an outlet pipe 613. The outlet assembly 62 is connected to the plasma hydrocarbon decomposition element 3 and has an admission pipe 621, a gas discharging area 622, a vibration absorption element 623, and an outlet pipe 624. The vibration absorption element 623 is solid and may be made of Teflon, or other chemical materials. The auxiliary connector 63 is connected to the admission assembly 61 and the outlet assembly 62. The movable valves 64, 65, 66 are arranged between the admission assembly 61 and the outlet assembly 62 and may move along the arrow direction, and are used to control the gas flow.

In operation, the high pressure gaseous carbon hydrogen compound is introduced into the admission assembly 61 at the admission pipe 611. When the movable valve 64 is opened and the movable valve 65 is closed, the gaseous carbon hydrogen compound is filled within the natural gas filling area 612. At this time, the pressure in the liquid fuel storage bottle 1 would be better to have ten times that of the ambient.

When the natural gas filling area 612 is finished with gas filling, the movable valve 64 is closed and the movable valve 65 is then opened. The gaseous carbon hydrogen compound enters the gas discharging area 622. At this time, the movable valve 66 is closed, and the gas flows out through an opening between the admission assembly 61 and outlet assembly 62. Since the pressure inside the gas pipe connector 6 is much higher than that outside, the gas flows out in an ultrasonic speed.

At this time, the air in the above mentioned opening flows out with the carbon hydrogen compound, the pressure in the opening is smaller than that outside and the opening must be closed. Next, the auxiliary connector 63 closely locks the admission and outlet assemblies 61, 62. When the admission and outlet assemblies 61, 62 contact to each other at an instant time, a vibration wave is generated and the vibration is absorbed by the vibration absorption element 623. Thus, even in the ambient environment, the air does not flow into the connected admission and outlet assemblies 61, 62.

FIG. 2B shows a modified gas pipe connector 6a of the version 6 shown in FIG. 2A. The gas pipe connector 6a differs in its Laval nozzle shape, where a gas flow has a cross section of from narrow gradually to then wide, enabling the gas discharging speed to be increased to an ultrasonic speed. The gas pipe connector 6a can reliably prevent any air from entering, and the operation process of the gas pipe connector 6a is also similar, in comparison with the connector 6 shown in FIG. 2A. In FIG. 2B, figure (a) shows that the gas pipe connector 6a is in a separated state, while figure (b) in a connected state. The gas pipe connector 6a has much higher flow speed of the discharged gas and a much larger connection force than that of the gas pipe connector 6a respectively. Accordingly, the possibility of air flowing into the connector 6a is relatively much lower.

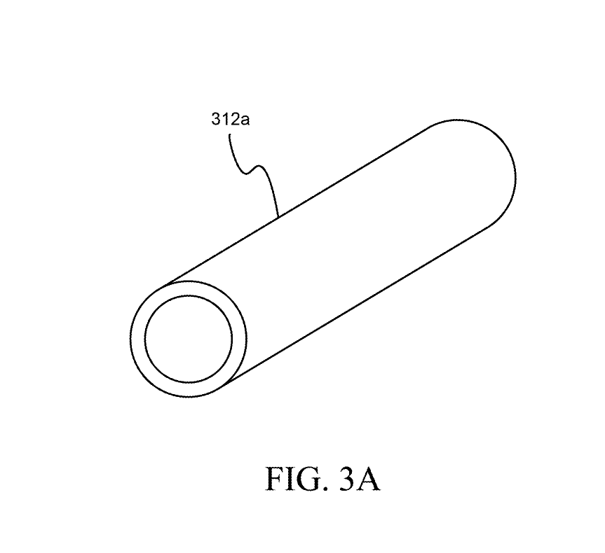

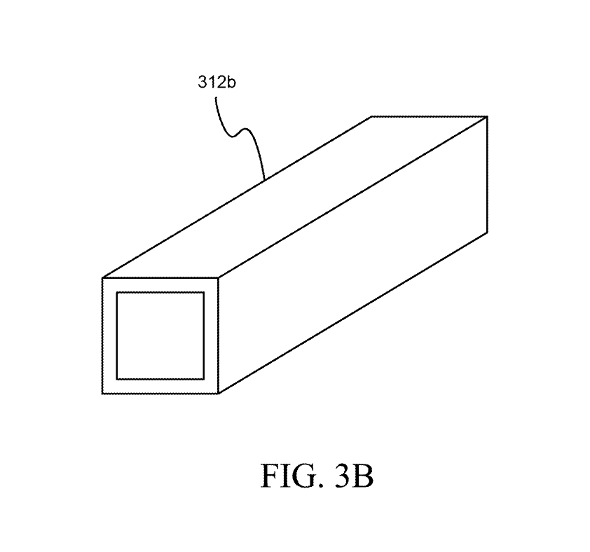

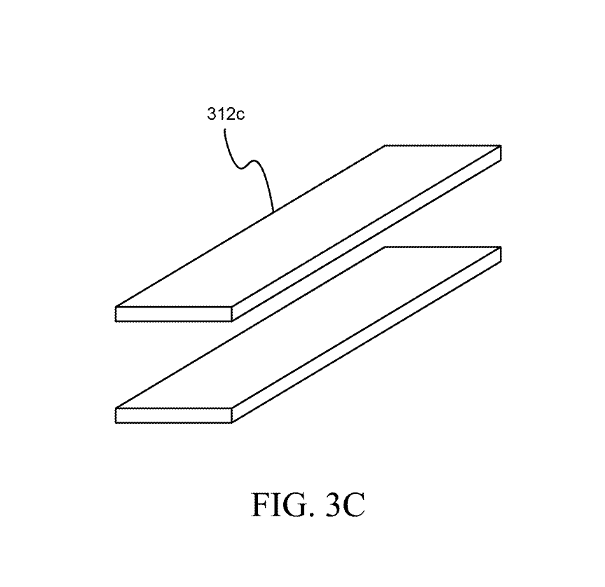

Now referring to FIG. 3A to FIG. 3C, schematic diagrams of the electrode structure according to three preferred embodiments of the present invention are shown therein, respectively. The pair of electrodes may be cylindrical electrode tube 312a, as shown in FIG. 3A, square electrode tube 312b, as shown in FIG. 3B, and dual-plate electrode plates 312c, shown in FIG. 3C. Alternatively, other modifications of the electrode pair may be possible.

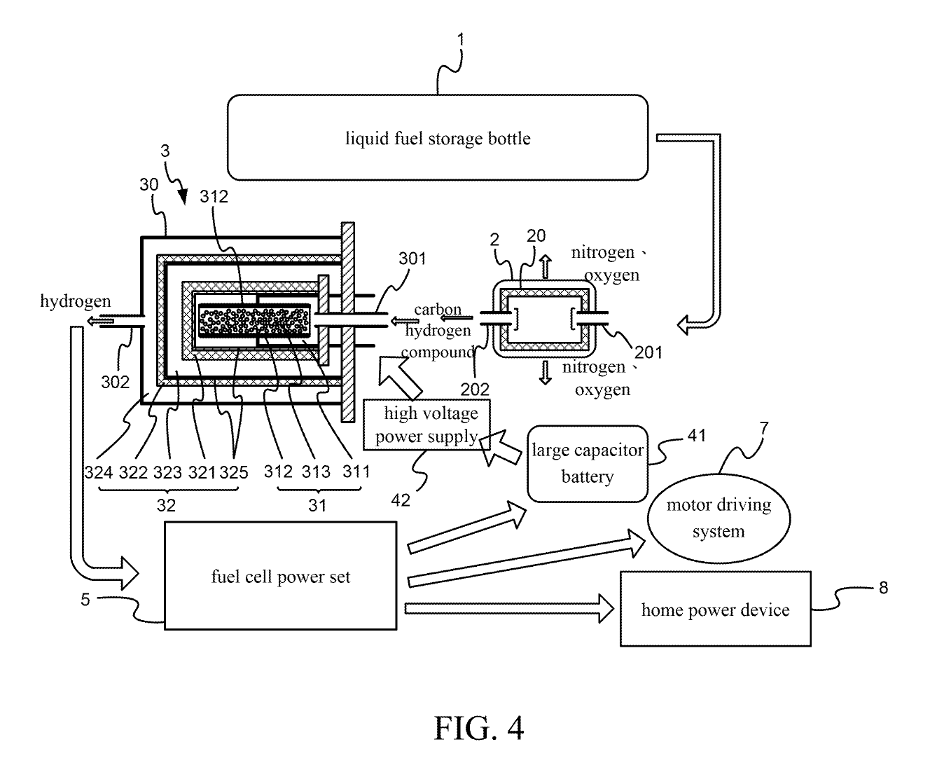

FIG. 4 to FIG. 6 are schematic diagrams of a use state of the plasma hydrogen generation device according to three preferred embodiments of the present invention, respectively. As shown, the system generating and purifying hydrogen for use in a car is supplied with electric power provided by the car, and the generated hydrogen may be directly provided to the fuel cell in the car to further provide electric power to drive the car.

The use state shown in FIG. 4 corresponds to an overall concept of hydrogen generation and input to the fuel cell and thus an output electric power generated, which may also be used in home power device use. In FIG. 4, the carbon hydrogen compound may be liquid propane (LPG), but other carbon hydrogen compounds may also be selected. All the system should be placed on a car.

The carbon hydrogen compound fuel from the liquid fuel storage bottle 1 is removed from air at the air filtering element 2 and the gas pipe connector (not shown) and then flows to the plasma decomposition area 311 of the plasma decomposition element 3, where purified hydrogen is produced and provided to the fuel cell power set 5. In summary, the entire system is composed of the carbon hydrogen compound fuel 1, air filtering element 2, gas pipe connector (not shown), hydrogen generation and purification used plasma decomposition element 3, the plasma hydrogen decomposition element operating with the high voltage power supply 42, the electric power generating fuel cell power set 5, the large capacitor battery 61 supplying electric power to the high voltage power supply 41, and the car motor driving system 7. This system runs without producing carbon dioxide or carbon monoxide, and thus can be an ideal clean car driving system. This system can be used directly in a car, in which the fuel cell power set 5 provides electric power to the large capacitor battery 6 for charging, or directly provides electric power to the motor driving system 7, or directly provides electric power to a home electric power device 8 with home or industry power specification.

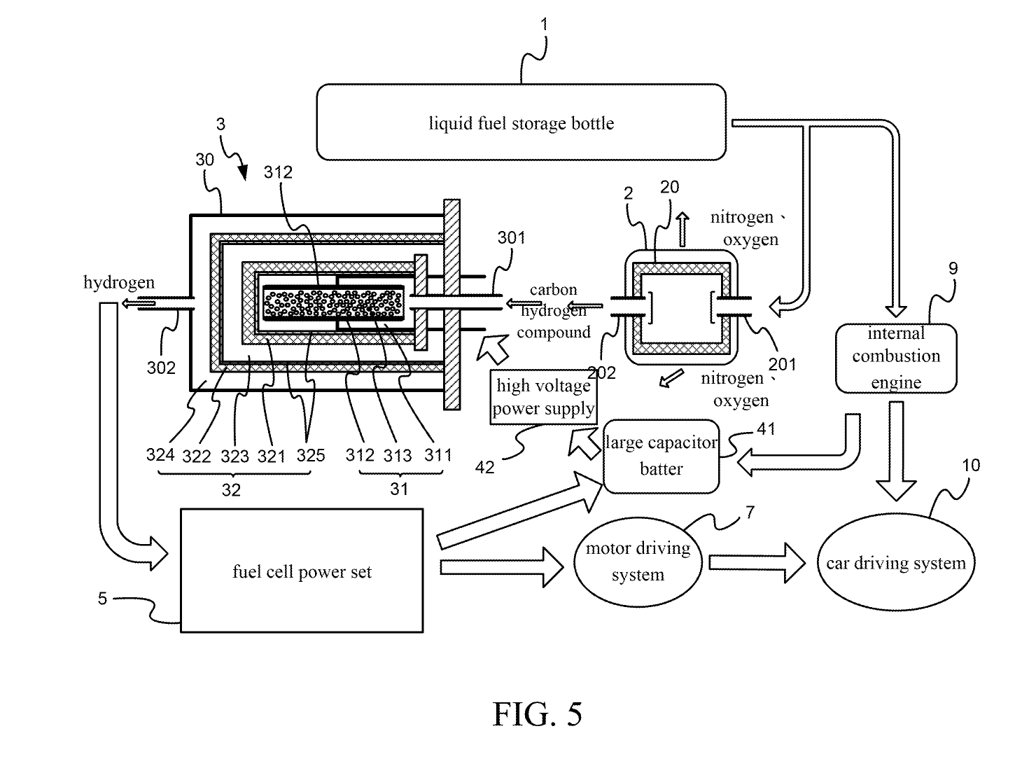

FIG. 5 shows a specific type of hydrogen hybrid driving system. A fuel cell in a car has to provide a sufficient electric power, but it may fail in some situations. In this case, the inventive system may be combined with the fuel cell to become a hydrogen hybrid car driving system. In FIG. 5, the fuel in the hydrogen hybrid driving system is propane gas, which can be served as the fuel for an internal combustion engine 9 and may also be served as the fuel for generating hydrogen in the plasma hydrocarbon decomposition element 3.

Therefore, the system is composed of the carbon hydrogen compound fuel 1, air filtering element 2, gas pipe connector (not shown), plasma hydrocarbon decomposition element 3 for hydrogen generation and purification, operating high voltage power supply 42 for the plasma hydrocarbon decomposition element 3, the electric power generating fuel cell power set 5, the large capacitor battery 61 for supplying electric power to the high voltage power supply 41, the car motor driving system 7, the internal combustion engine 9 and the car driving system 10. In this hydrogen hybrid car driving system, although hydrogen fuel cell does not generate carbon dioxide, the internal combustion engine generates carbon dioxide. However, this hydrogen hybrid car driving system generates much lower carbon dioxide amount than that of a single internal combustion engine system using propane gas as the fuel, enabling the possibility of the combination of the inventive system and the internal combustion engine. In this case, the fuel cell power set 5 provides electric power to the large capacitor battery 6 for charging, or directly provides electric power to the motor driving system 7 to operate the car driving system 10. In operation of the internal combustion engine 9, the resulting electric power may also be provided to the large capacitor battery 6 for charging and to the high voltage power supply 42 operating the plasma hydrocarbon decomposition element 3, or directly to the car electric motor driving system 10.

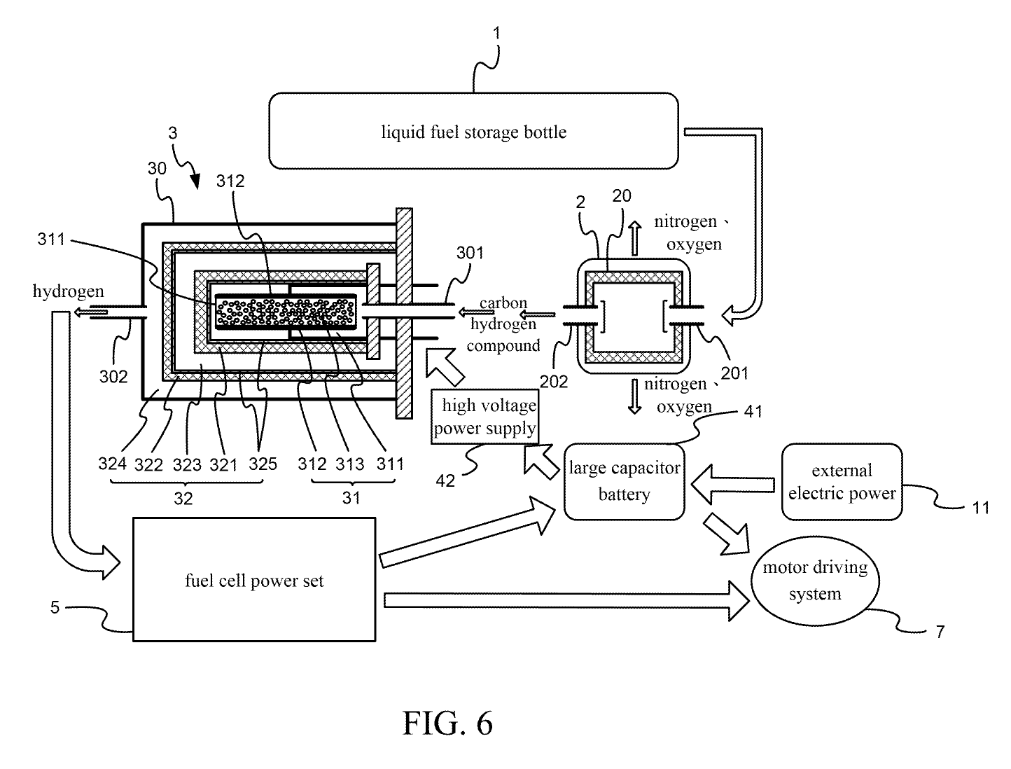

FIG. 6 shows yet another type of hydrogen hybrid driving system, in which an electric vehicle (EV) car is used in replace with the internal combustion engine system and in combination with the inventive system to become a hydrogen hybrid EV car. In FIG. 6, the internal combustion engine is removed while the large capacitor battery 41 is used with the fuel cell power set 5. The large capacitor battery 41 provides the main electric power to the motor driving system 7 and the other portion to the plasma hydrocarbon decomposition element 3 through the high voltage power supply 42. In addition, the electric power from the fuel cell power set 5 may also be provided to the large capacitor power set 5 for charging. Thus, the required amount of electric power provided to the large capacitor battery 6 by a public power supplying system may be reduced. Since the electricity plant usually produces a large amount of carbon dioxide, nitrogen oxide or sulfur oxide, the EV car system cannot be viewed as a clean system in a strict sense. However, when the EV car system is used in combination with the inventive device, the charging requirement for the large capacitor battery 6 from the public power supply system may be reduced. Thus, the hydrogen hybrid EV car system is cleaner than the single EV car system, and the inventive device may be further used with EV car driving system. In this case, the fuel cell power set 5 provides electric power to the large fuel cell power set 5 for charging, or directly provides electric power to the motor driving system 7 to become a hydrogen hybrid EV car. If necessary, the large capacitor battery 41 may also be charged by using an external power supply.

As such, the resulting electric power may be directly used as electric power required by the car, for supplying it to charge the large capacitor battery or directly supplying electric power to a car motor driving system, or directly provides electric power to a home electric power device with home or industry electricity specification. Further, it is also suitable for use in combination with an EV car driving system to provide electric power to charge the large capacitor battery to become a hydrogen hybrid EV car, or in combination with an internal combustion engine to become a hydrogen hybrid car driving system, by which the requirement for charging a large capacitor battery may be considerably reduced.

In addition, the plasma hydrogen generation device can be further used in combination with an internal combustion engine with a liquid carbon hydrogen compound as a fuel to provide electric power to the large capacitor battery system, and directly supplying electric power to an electric motor driving system to become a hydrogen hybrid car driving system.

In summary, the present invention provides a plasma hydrogen generation device used for a new energy car capable of hydrogen generation and purification and operation with a battery and with high efficiency, which can effectively overcome the shortcoming encountered in the prior art. This inventive device comprises a liquid fuel storage bottle, an air filtering element, a large capacitor battery and a fuel cell power set. In operation, a carbon hydrogen compound is decomposed into hydrogen and carbon without carbon dioxide generated when a liquid carbon hydrogen compound is decomposed in the plasma hydrocarbon decomposition element. The resulting hydrogen is directly provided to a fuel cell on the car to generate electric power, and thus the subject device may be used in a series of clean and green energy cars. As such, the resulting electric power may be directly used as the power required by the car. Further, it is also suitable for a home electric power device with home and industry electricity specification, or used in combination with an EV car driving system to become a hydrogen hybrid electric powered car, or used in combination with a natural gas internal combustion engine to become a hydrogen hybrid car driving system.

Therefore, the present invention can be deemed as more environment friendly and more energy efficient, compared with the prior art.

The above description is merely examples and preferred embodiments of the present invention, and not exemplified to intend to limit the present invention. Any modifications and changes without departing from the scope of the spirit of the present invention are deemed as within the scope of the present invention. The scope of the present invention is to be interpreted with the scope as defined in the appended claims.

1. A plasma hydrogen generation device used for a new energy car, comprising:
a liquid fuel bottle, supplying a liquid carbon hydrogen compound as a fuel;
an air filtering element, comprising a filtering cavity having a filtering entrance and a filtering exit, having a first filtering area and a second filtering area, receiving the liquid carbon hydrogen compound from the liquid fuel storage bottle through the filtering cavity entrance and filtering the liquid carbon hydrogen compound to remove an air contained in the gaseous carbon hydrogen compound;
a plasma hydrocarbon decomposition element, comprising a plasma cavity having a plasma cavity entrance communicated to the filtering cavity exit and a plasma cavity exit, and being composed of a plasma reactor and a double-layered gas filter covering the plasma reactor, the plasma reactor having a plasma hydrocarbon decomposition area and at least a pair of electrodes, wherein the plasma hydrocarbon decomposition element guides the air filtered gaseous carbon hydrogen into a plasma hydrocarbon decomposition area thereof, in which the gaseous carbon hydrogen compound is decomposed into hydrogen gas and carbon particles by plasma discharging at a discharging space within the pair of electrodes by applying short rise time high voltage impulses, and then the gas filtering element purifies the output hydrogen by removing the carbon particles mixed in the hydrogen and a portion of carbon hydrogen compound without being decompressed out of the gaseous carbon hydrogen compound originally in the gas filtering gas;
a high voltage power supply, connected to the pair of electrodes of the plasma hydrocarbon decomposition element to supply a high voltage impulse power for operating the plasma reactor;
a fuel cell power set, connected to the plasma hydrocarbon decomposition element for receiving the purified hydrogen to generate electric power; and
a large capacitor battery, receiving the electric power and supplying the electric power to the high voltage power supply.
All of those system works on a moving vehicle.

2. The plasma hydrogen generation device according to claim 1, wherein the liquid carbon hydrogen compound is a liquid natural gas, comprising methane, propane, or butane.

3. The plasma hydrogen generation device according to claim 1, wherein the filtering cavity of the air filtering element is composed of a filtering layer absorption air molecules and preventing absorption the carbon hydrogen compound.

4. The plasma hydrogen generation device according to claim 1, wherein a gas pipe connector is further arranged between the liquid fuel storage bottle and the plasma hydrocarbon decomposition element, and capable of replacing the air filtering element or use in combination with the air filtering element.

5. The plasma hydrogen generation device according to claim 4, wherein the gas pipe connector has an axial symmetric structure and comprises a gas inlet assembly connected to the liquid fuel storage bottle having an inlet gas pipe, a natural gas filling area and an outlet pipe; a gas outlet assembly connected to the plasma hydrocarbon decomposition element and having a gas inlet pipe, a gas discharging area, a vibration wave absorption element and a gas outlet pipe, an auxiliary connector connected to the gas inlet assembly and the gas outlet assembly, and a plurality of movable valves arranged between the gas inlet assembly and the gas outlet assembly to control a pass of a gas.

6. The plasma hydrogen generation device according to claim 5, wherein the gas discharging area of the air pipe connector has a Laval nozzle shape having a cross section first narrow and then wide along a direction of the gas discharged, to let the gas discharged flow increase to an ultrasonic speed.

7. The plasma hydrogen generation device according to claim 1, wherein the plasma reactor is an internally decomposition type reactor, and includes a dielectric shield discharging plasma reactor and a dielectric catalyst plasma reactor.

8. The plasma hydrogen generation device according to claim 1, wherein the pair of electrodes has a shape including cylindrical, square, double-plates, and a geometrical shape of a medication thereof.

9. The plasma hydrogen generation device according to claim 1, wherein a pressure within the plasma hydrocarbon decomposition area in the plasma reactor is greater than 1 atm and smaller than 10 atm.

10. The plasma hydrogen generation device according to claim 1, wherein each of the catalyst particles is selected from a group consisting of aluminum phosphate (AlPO₄), aluminum oxide (Al₂O₃), barium titanium oxide (BaTiO₃).

11. The plasma hydrogen generation device according to claim 1, wherein the air filtering element is a double-layered filtering element having an internal layer filtering unit and an external layer filtering unit covering the internal filtering unit, the internal filtering unit being arranged circumferentially outside the plasma hydrocarbon decomposition area, wherein the gaseous carbon hydrogen compound is decomposed by the plasma into a mixture of hydrogen, carbon particles and undecomposed gaseous carbon hydrogen compound, the internal filtering unit first blocks the carbon particles, then the external filtering unit of the first filtering area filters out the undecomposed gaseous carbon hydrogen compound, and the second filtering area purifies the hydrogen.

12. The plasma hydrogen generation device according to claim 11, wherein a pressure of the first filtering area is smaller than the pressure of the plasma hydrocarbon decomposition area and greater than the pressure of the second filtering area which is greater than 1 atm.

13. The plasma hydrogen generation device according to claim 11, wherein the undecomposed gaseous carbon hydrogen compound blocked by the external filtering unit is collected and recycled back to the plasma reactor to be decomposed again.

14. The plasma hydrogen generation device according to claim 11, wherein an internal wall of each of the internal and external filtering units is arranged with an isolation assembly forming an isolation space.

15. The plasma hydrogen generation device according to claim 1, wherein the carbon particles are stored within the plasma reactor and taken out in a routine cleaning access.

16. The plasma hydrogen generation device according to claim 1, wherein the high voltage power supply provides voltage impulses having a repetition frequency between 1 KHz and 1 MHz.

17. The plasma hydrogen generation device according to claim 1, wherein the high voltage power supply provides a voltage having an impulse width of between 1 μs and 1 ns.

18. The plasma hydrogen generation device according to claim 1, wherein the plasma hydrogen generation device is applied on a situation including directly used in a car by providing electric power to charge the large capacitor battery, directly providing electric power to a motor driving system of a driving car, or directly providing electric power to a home electric power device with home or industry power specifications, respectively.

19. The plasma hydrogen generation device according to claim 1, wherein the plasma hydrogen generation device is used in a situation including in combination with an internal combustion engine using liquid carbon hydrogen compound as a fuel to provide electric power to the large capacitor battery system, and directly supplying electric power to a motor driving system to become a hydrogen hybrid car driving system, wherein the electric power generated in the internal combustion engine is partly provided to the large capacitor battery while the other to the car driving system.

20. The plasma hydrogen generation device according to claim 1, wherein the plasma hydrogen generation device is combined with an EV car for a function including providing electric power to charge the large capacitor, and directly providing electric power to a motor driving system to become a hydrogen hybrid EV car, wherein the electric power from the large capacitor battery is mainly provided to the motor driving system while partly to the plasma hydrocarbon decomposition element, and the large capacitor battery can be selectively charged by an external power.
